(19) United States
(12) Patent Application Publication
(10) Pub. No.: US 2020/0278579 A1
(43) Pub. Date: Sep. 3, 2020

(54) COLOR FILTER SUBSTRATE, MANUFACTURING METHOD THEREOF, AND DISPLAY DEVICE

(71) Applicants: ORDOS YUANSHENG OPTOELECTRONICS CO., LTD., Ordos, Inner Mongolia (CN); BOE TECHNOLOGY GROUP CO., LTD., Beijing (CN)

(72) Inventors: Chunhong MA, Beijing (CN); Heewoong KIM, Beijing (CN); Baojie ZHAO, Beijing (CN)

(21) Appl. No.: 16/647,698

(22) PCT Filed: Jul. 29, 2019
(86) PCT No.: PCT/CN2019/098214

§ 371 Date: Mar. 16, 2020

(30) Foreign Application Priority Data
Aug. 24, 2018 (CN) 201810971887.7

(51) Int. Cl. G02F 1/1335

(52) U.S. Cl. CPC G02F 1/133516; G02F 1/133512

(57) ABSTRACT

Embodiments of the present disclosure provide a color filter substrate, a manufacturing method thereof, and a display device. The color filter substrate includes a substrate, color blocks, and light shielding portions positioned on the substrate. The color blocks and the light shielding portions are alternately arranged along a first direction. A size of the light shielding portions along the first direction depends on a sensitivity of human eyes to a mixture of colors, which are different, of the color blocks on both sides of each of the light shielding portions.

### CROSS REFERENCE TO RELATED APPLICATIONS

This patent application is a National Stage Entry of PCT/CN2019/098214 filed on Jul. 29, 2019, which claims the benefit and priority of Chinese Patent Application No. 201810971887.7 filed on Aug. 24, 2018, the disclosures of which are incorporated by reference herein in their entirety as part of the present application.

### BACKGROUND

Embodiments of the present disclosure relate to the field of display technologies, and particularly, to a color filter substrate, a method for manufacturing a color filter, and a display device.

A liquid crystal display device is one of display devices which are widely used at present. The liquid crystal display device mainly includes an array substrate, a color filter substrate, a polarizer, a backlight, and a liquid crystal. The color filter substrate is usually configured to implement color display. Each pixel of the color filter substrate may includes three sub-pixels of red (R), green (G), and blue (B).

### BRIEF DESCRIPTION

Embodiments of the present disclosure provide a color filter substrate, a manufacturing method thereof, and a display device.

A first aspect of the present disclosure provides a color filter substrate. The color filter substrate includes a substrate, color blocks, and light shielding portions positioned on the substrate. The light shielding portions and the color blocks are arranged alternately along a first direction. A size of the light-shielding portions along the first direction depends on a sensitivity of human eyes to a mixture of colors, which are different, of the color blocks on both sides of each of the light shielding portions.

In an embodiment of the present disclosure, the size of the light shielding portions is proportional to the sensitivity of the human eyes to the mixtures of the colors of the color blocks on both sides of each of the light shielding portions.

In an embodiment of the present disclosure, the size of the light shielding portion with the sensitivity of the human eyes to the mixture of the colors of the color blocks on both sides being smaller than a predetermined threshold is smaller than the size of the light shielding portion with the sensitivity of the human eyes to the mixture of the colors of the color blocks on both sides being larger than the predetermined threshold.

In an embodiment of the present disclosure, the sizes of the color blocks along the first direction are the same.

In an embodiment of the present disclosure, the color blocks include a red color block, a green color block, and a blue color block provided in the first direction. The light shielding portions include a first light shielding portion provided between the red color block and the blue color block, a second light shielding portion provided between the red color block and the green color block, and a third light shielding portion provided between the green color block and the blue color block. The size of the third light shielding portion is smaller than the size of the first light shielding portion and the size of the second light shielding portion.

In an embodiment of the present disclosure, the size of the first light shielding portion is smaller than the size of the second light shielding portion.

In an embodiment of the present disclosure, the size of the first light shielding portion is about 4.0 μm, the size of the second light shielding portion is about 4.5 μm, the size of the third light shielding portion is about 3.5 μm, and the sizes of the color blocks is about 15 μm.

A second aspect of the present disclosure provides a display device. The display device includes a color filter substrate according to the first aspect of the present disclosure and an array substrate. Light shielding layers at least partially overlapped with the light shielding portions of the color filter substrate in a direction perpendicular to the substrate are provided on the array substrate at intervals.

A third aspect of the present disclosure provides a method for manufacturing a color filter substrate according to the first aspect of the present disclosure. In the method, a substrate is provided, and then color blocks and light shielding portions are formed on the substrate. The color blocks and the light shielding portions are alternately arranged along a first direction. A size of the light shielding portions along the first direction depends on a sensitivity of human eyes to a mixture of colors, which are different, of the color blocks on both sides of each of the light shielding portions.

In an embodiment of the present disclosure, the size of the light shielding portions is set to be proportional to the sensitivity of the human eyes to the mixture of the colors of the color blocks on both sides of each of the light shielding portions.

In an embodiment of the present disclosure, the size of the light shielding portion with the sensitivity of the human eyes to the mixture of the colors of the color blocks on both sides being smaller than a predetermined threshold is set to be smaller than the size of the light shielding portion with the sensitivity of human eye to the mixture of the colors of the color blocks on both sides being larger than the predetermined threshold.

### BRIEF DESCRIPTION OF THE DRAWINGS

In order to illustrate the technical solutions of the present disclosure more clearly, the drawings of the embodiments will be briefly described below. It can be understood that the drawings described below are only related to some of the embodiments of the present disclosure, rather than limiting the present disclosure, wherein like reference signs indicate like elements or signals, in which:

FIG. 1 shows a schematic cross-sectional view of a display device;

FIG. 2 shows a schematic plan view of a color filter substrate of the display device shown in FIG. 1;

FIG. 3 shows a schematic cross-sectional view in a case that the color filter substrate and the array substrate of the display device shown in FIG. 1 are not accurately aligned;

FIG. 4 shows a schematic cross-sectional view of a color filter substrate according to an embodiment of the present disclosure;

FIG. 5 shows a schematic plan view of a color filter substrate according to an embodiment of the present disclosure;

FIG. 6 shows a schematic cross-sectional view of a display device according to an embodiment of the present disclosure;

FIG. 7 shows a schematic cross-sectional view in a case that a color filter substrate and an array substrate of a display device are not accurately aligned, according to an embodiment of the present disclosure; and

FIG. 8 shows a schematic flowchart of a method for manufacturing a color filter substrate according to an embodiment of the present disclosure.

### DETAILED DESCRIPTION

In order to make the technical solutions and advantages of the embodiments of the present disclosure clearer, the technical solutions of the embodiments of the present disclosure will be clearly and completely described below in conjunction with the accompanying drawings. Obviously, the described embodiments are merely part of the embodiments of the present disclosure, rather than all of the embodiments. According to the described embodiments, all the other embodiments obtained by those of ordinary skill in the art without creative labor also fall within the scope of protection of the present disclosure.

First of all, it can be noted that, unless otherwise stated in the context, singular forms of terms used herein and in the appended claims include plural forms, and vice versa. Thus, when referring to a singular number of a term, the plural of the corresponding term may also be included. Similarly, the terms “including” and “comprising” are to be construed as inclusive and not exclusive, unless such interpretation is explicitly prohibited herein. Where the term “example” is used herein, particularly when it comes after a set of terms, the “example” is merely exemplary and illustrative, and should not be considered exclusive or extensive.

In addition, in the drawings, thickness and area of each layer are exaggerated for clarity. It can be understood that when referring to a layer, a region, or a component “on” another part, it means that it is directly on the other part, or there may be other components in between. In contrast, when a component is referred to as being “directly on” another part, it means that no other component is in between. The orientations or positional relationships indicated by the terms “top”, “down”, “left”, “right”, “inside”, “outside” and the like are based on the orientations or positional relationships shown in the drawings, and are merely for the convenience of describing the present disclosure and simplifying the description. This does not indicate or imply that the part or element referred to must have a particular orientation, or be constructed and operated in a particular orientation, therefore it should not be construed as limiting the present disclosure.

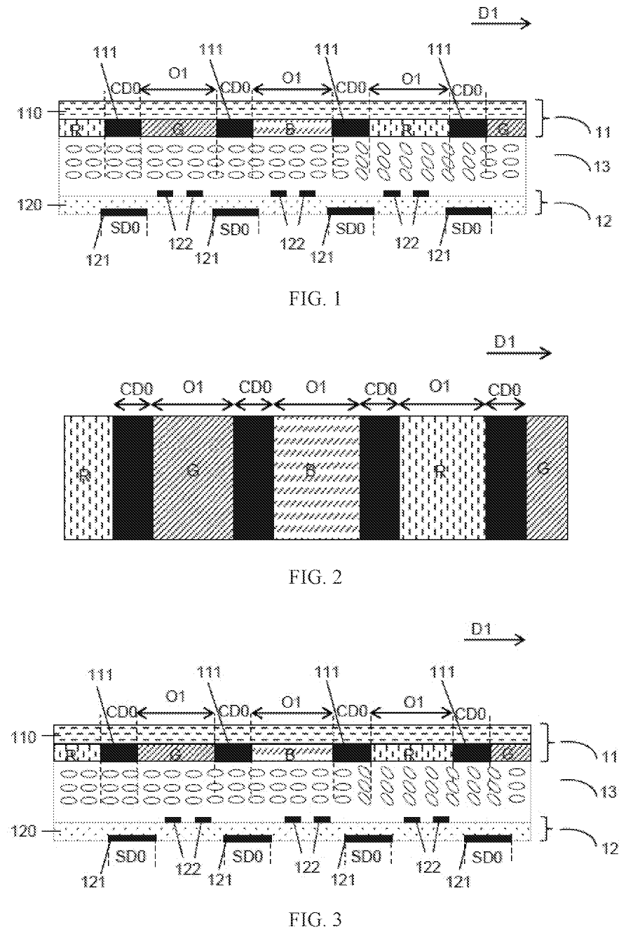

FIG. 1 shows a schematic cross-sectional view of a part of a display device. As shown in FIG. 1, the display device is, for example, a liquid crystal display device. The liquid crystal display device may include a color filter substrate 11, an array substrate 12, a liquid crystal layer 13 between the two substrates, and a backlight unit (not shown) below the array substrate 12.

The color filter substrate 11 may include a substrate 110, color blocks, and light shielding portions 111. According to an embodiment of the present disclosure, the color blocks may include a red color block R, a green color block G, and a blue color block B. FIG. 2 is a schematic plan view of a color filter substrate of the display device shown in FIG. 1. As shown in FIGS. 1 and 2, the color blocks and the light shielding portions 111 are alternately arranged. Sizes O1 of the red color block R, the green color block G, and the blue color block B along a first direction D1 (for example, a direction parallel to the surface of the substrate 110) are the same, which are, for example, 15 μm. A size CD0 of each light-shielding portion 111 along the first direction D1 is the same, which is, for example, 4.0 μm.

As shown in FIG. 1, the array substrate 12 may include light shielding layers (where thin film transistors TFT are formed, for example) 121, a dielectric layer 120 (for example, a non-conductive layer), and pixel electrodes 122. The light-shielding layers 121 are arranged in accordance with the light-shielding portion 111 and can block light emitted from the backlight unit. According to an embodiment of the present disclosure, a size SD0 of the light shielding layers 121 may be larger than a size CD0 of the light shielding portions 111 along the first direction D1. For example, the size SD0 of the light shielding layers 121 is 4.5 μm. The pixel electrodes 122 may be controlled by a circuit. An electric field may be formed between the pixel electrode 122 and a common electrode (not shown), such that the liquid crystal molecules in the liquid crystal layer 13 may be deflected. After the light from the backlight unit passes through the array substrate 12, the liquid crystal layer 13, and the color filter substrate 11 sequentially, the display device may present colors and grayscale brightness.

In a case where the color filter substrate 11 and the array substrate 12 are accurately aligned with each other, when the liquid crystal molecules below a color block are deflected according to a voltage of the pixel electrode 122 on the array substrate 12, the light emitted by the backlight unit passes through the color block, such that corresponding color can be displayed at corresponding position of the display device. As shown in FIG. 1, when the voltage of the pixel electrode 122 deflects the liquid crystal molecules below the red color blocks R, light passes through the red color blocks R, such that the display device presents red color. Moreover, when the voltage of the pixel electrode 122 controls the liquid crystal molecules below the green color blocks G to deflect, light passes through the green color blocks G, such that the display device presents green color. When the voltage of the pixel electrode 122 controls the liquid crystal molecules below the blue color blocks B to deflect, light passes through the blue color blocks B, such that the display device presents blue color. Light shielding portions 111 are provided on both sides of each color block to prevent light from passing through two color blocks with different colors at the same time, which may cause color mixing. Therefore, when the color filter substrate 11 and the array substrate 12 are accurately aligned without any relative displacement between them, human eyes may not observe cross-color phenomenon at a side viewing angle for a monochrome picture (red/green/blue).

However, for the display device, due to the influence of the respective manufacturing processes of the array substrate and the color filter substrate, alignment process and equipments, and the like, there can be a relative offset between the array substrate and the color filter substrate after the alignment process, that is, they are inaccurate aligned. When the offset reaches a certain level, the light from the backlight unit may pass through the color blocks of two colors at the same time for a monochrome picture. When viewed from a side viewing angle (such as when the angle between a direction of the human eyes and a surface of the display panel is 30°, 45°, or 60°), the human eyes can observe cross-colors among multiple colors.

FIG. 3 shows a schematic cross-sectional view of the color filter substrate and the array substrate of the display device shown in FIG. 1, in which the two substrates are not accurately aligned. As shown in FIG. 3, the array substrate 12 is offset from the color filter substrate 11 to the right by a certain distance. Accordingly, the pixel electrodes 122 on the array substrate 12 are also shifted to the right. When the pixel electrodes 122 are controlled in the same manner as describe above with respect to FIG. 1, not only the liquid crystal molecules below the red color blocks R are deflected, but also a part of the liquid crystal molecules below the green color blocks G on the right side is also deflected.

In this case, because the size CD0 of the light shielding portion 111 is small, light can pass through the red color blocks R and the green color blocks G at the same time, the human eyes may observe a mixed color of red and green, i.e., yellow, in the side viewing angle for a red picture or a green picture. Similarly, when light passes through the red color blocks R and the blue color blocks B at the same time, the human eyes may observe a mixed color of red and blue, i.e., purple, in the side viewing angle for a red picture or a blue picture. When light passes through the green color blocks G and the blue color blocks B at the same time, the human eyes may observe a mixed color of green and blue, i.e., cyan, in the side viewing angle for a green picture or a blue picture.

Generally, the size of each light shielding portion is the same. The risk of color mixing can be reduced by increasing the sizes of all light shielding portions. However, this will affect the transmittance of the display device. Limited by the requirement of transmittance, the degree of increase in the size of the light shielding portions is limited. Therefore, the degree of reducing the risk of color mixing based on such method is extremely limited. Meanwhile, the transmittance of the display device may be compromised.

Because the human eyes have different sensitivity to different colors, the sensitivity to a mixture of colors is also different. For example, because the human eyes are more sensitive to yellow, it may be easier for the human eyes to observe the yellow color, that is, the mixture of red and green, in the red or green picture. Moreover, because the human eyes are relatively insensitive to cyan, the human eyes may omit the mixture of green and blue, in the blue or green picture.

In embodiments of the present disclosure, the sizes of the light-shielding portions can be adjusted based on the sensitivity of the human eyes to a mixture of colors, which are different. The light-shielding portion at a location with a higher risk of color mixing (that is, the human eyes can easily observe the mixture of the colors at this location) has a wider size. On the contrast, the light-shielding portion at a location with a lower risk of color mixing has a narrow size. Descriptions can be made in detail with reference to the embodiments below.

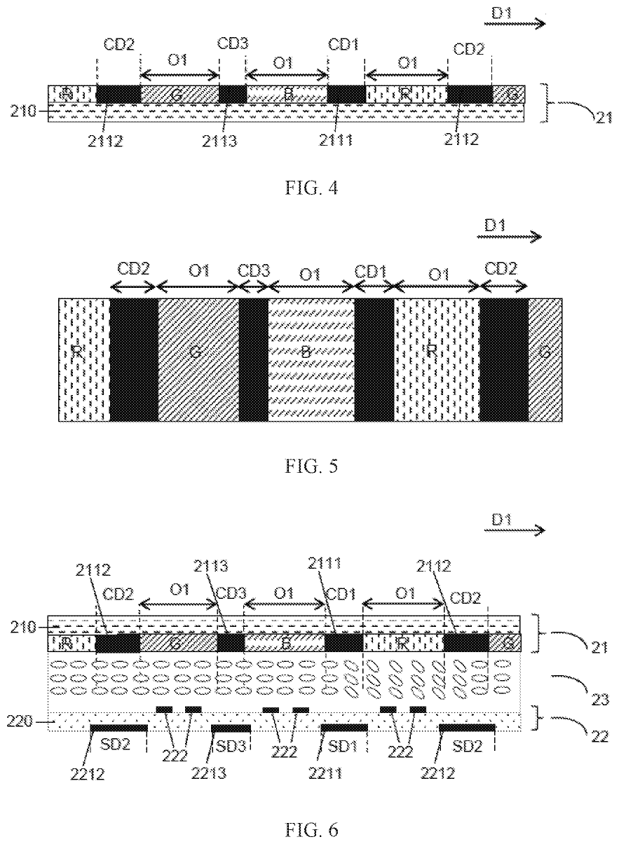

FIG. 4 illustrates a schematic cross-sectional view of a color filter substrate according to an embodiment of the present disclosure. As shown in FIG. 4, the color filter substrate 21 includes a substrate 210, color blocks and light shielding portions positioned on the substrate 210. The color blocks and the light shielding portions are alternately arranged along a first direction D1 (for example, a direction parallel with the surface of the substrate 210). In an embodiment, the color blocks may include a red color block R, a green color block G, and a blue color block B arranged along the first direction D1. The light shielding portions may include a first light shielding portion 2111 between the red color block R and the blue color block B, a second light shielding portion 2112 between the red color block R and the green color block G, and a third light shielding portion 2113 between the green color block G and the blue color block.

The size of each light shielding portion along the first direction D1 depends on the sensitivity of the human eyes to the mixtures of the colors of the color blocks on both sides of the light shielding portion. Specifically, the size CD1 of the first light shielding portion 2111 depends on the sensitivity of the human eyes to the mixed color (i.e., purple) of blue and red, the size CD2 of the second light shielding portion 2112 depends on the human eyes to the mixed color (i.e., yellow) of red and green, and the size CD3 of the third light-shielding portion 2113 depends on the sensitivity of the human eyes to the mixed color (i.e., cyan) of green and blue.

Table 1 below shows occurrence rates (i.e., probabilities) of color mixing at different sizes of the light shielding portion and different viewing angles, when the color filter substrate and the array substrate have a misalignment of 2.5 μm.

TABLE 1

| | 3.5 μm | 4 μm | 4.5 μm |
|---|---|---|---|
| 0° | 0.64% | 0.45% | 0.32% |
| 45° | 1.15% | 0.87% | 0.67% |

As shown in Table 1, increasing the size of the light shielding portion may be beneficial to reduce the probability of color mixing, while reducing the size of the light shielding portion may increase the probability of color mixing. In addition, the larger the viewing angle is, the higher the probability of color mixing is. In the embodiment, the size of the light shielding portion at a location, where the human eyes can easily observe the mixed color, can be increased, to reduce the probability of observing the mixed color by the human eyes. Moreover, the size of the light shielding portion at a location, where the mixed color can hardly be seen by the human eyes, can be decreased, thereby ensuring the transmittance of the display device.

In an embodiment of the present disclosure, the size of the light shielding portion may be configured to be proportional to the sensitivity of the human eyes to the mixtures of the colors of the color blocks on both sides of each of the light shielding portions. It can be understood that the sensitivity of the human eyes to yellow, purple, and cyan decreases in order. For example, as the mixture of the colors of the color blocks on both sides of the second light shielding portion 2112 is yellow and the sensitivity of the human eye to the yellow color is high, the size CD2 of the second light shielding portion 2112 can be increased, for example, 4.5 μm. In this case, the risk of viewing the mixed color can be reduced. In addition, as the mixture of colors of the color blocks on both sides of the first light-shielding portion 2111 is purple, and the sensitivity of the human eyes to purple is lower than that of yellow, the size CD1 of the first light-shielding portion 2111 can be set smaller than the size CD2 of the second light-shielding portion 2112, for example, 4.0 μm. That is, compared with the color filter substrate in FIG. 1, the size CD1 of the first light-shielding portion 2111 maintains the same, thus the risk of viewing the mixed color does not change. Furthermore, the mixture of the colors of the color blocks on both sides of the third light shielding portion 2113 is cyan, which can easily be overlooked by the human eyes. Therefore, when the offset between the two substrates is within a certain range, the risk of color mixing can be ignored. Therefore, the size CD3 of the third light shielding portion 2113, for example, 3.5 μm can be reduced, to ensure the transmittance of the display device unchanged. FIG. 5 shows a schematic plan view of a color filter substrate according to an embodiment of the present disclosure, wherein the color filter substrate is configured with a structure of the color filter substrate 21 in FIG. 4, for example.

In another embodiment, the size of the light shielding portion with the sensitivity of the human eyes to the mixture of the colors of the color blocks on both sides being smaller than a predetermined threshold can be set as smaller than the size of the light shielding portion with the sensitivity of the human eyes to the mixture of the colors of the color blocks on both sides being larger than the predetermined threshold. According to the embodiment of the present disclosure, the predetermined threshold may be set according to actual needs based on the sensitivity of the human eyes to the color mixed by two different colors. For example, the predetermined threshold may be set as follows, the human eyes are less sensitive to a color mixed by two colors when the sensitivity to the mixed color by the human eyes is lower than the predetermined threshold, and the human eyes are more sensitive to a color mixed by two colors when the sensitivity to the mixed color by the human eyes is higher than the predetermined threshold. For example, in the configuration of the color blocks in FIG. 4, the predetermined threshold can be set such that the predetermined threshold is greater than the sensitivity to the mixed color of green and blue of the green color block and the blue color block on both sides of the third light shielding portion 2113. Moreover, the predetermined threshold can be set such that the predetermined threshold is smaller than the sensitivity to the mixed color of red and green of the red color block and the green color block on both sides of the second light shielding portion 2112, and the sensitivity to the mixed color of blue and red of the blue color block and the red color block on both sides of the first light shielding portion 2111. For example, the size CD3 of the third light shielding portion 2113 may be configured to be smaller than the size CD1 of the first light shielding portion 2111, and smaller than the size CD2 of the second light shielding portion 2112. Further, the size CD1 of the first light shielding portion 2111 and the size CD2 of the second light shielding portion 2112 may be configured according to the actual situation of color mixing, thus the respective sizes of CD1 and CD2 are not specifically limited. For example, the size CD1 of the first light shielding portion 2111 may be larger than the size CD2 of the second light shielding portion 2112, the size CD1 of the first light shielding portion 2111 may be equal to the size CD2 of the second light shielding portion 2112, or the size CD1 of the first light shielding portion 2111 may be smaller than the size CD2 of the second light shielding portion 2112.

Moreover, as shown in the figure, the sizes O1 of the red color block R, the blue color block B, and the green color block G along the first direction D1 are all the same, such as, 15 μm. This ensures the transmittance of the display device.

According to embodiments of the present disclosure, based on the sensitivity of the human eyes to the mixed color, the risk of viewing color mixing can be reduced by implementing the light shielding portions with multiple widths. The width of the light shielding portion in the position where the probability of color mixing is high can be arranged to be wide, while the width of the light shielding portion in the position where the probability of color mixing is low can be arranged to be narrow. Therefore, it can improve the problem of color mixing without reducing the transmittance.

Based on the above, a display device can be further provided in an embodiment of the present disclosure.

FIG. 6 illustrates a schematic cross-sectional view of a display device according to an embodiment of the present disclosure. As shown in FIG. 6, the display device includes the color filter substrate 21 described above, an array substrate 22, a liquid crystal layer 23 between the two substrates, and a backlight unit (not shown) below the array substrate 22.

Light shielding layers at least partially overlapped with the light-shielding portions of the color filter substrate 21 are provided on the array substrate 22 at intervals. Specifically, the light shielding layer may include a first light shielding layer 2211 at least partially overlapped with the first light shielding portion 2111, a second light shielding layer 2212 at least partially overlapped with the second light shielding portion 2112, and a third light shielding layer 2213 at least partially overlapped with the third light shielding portion 2113.

As shown in FIG. 6, the size of the light shielding layer in the first direction D1 is slightly larger than the size of the corresponding light shielding portion. In an embodiment, the size of the light shielding layer corresponding to the light shielding portion at the position where the risk of color mixing is high is larger than the size of the light shielding layer corresponding to the light shielding portion at the position where the risk of color mixing is low. For example, the size CD1 of the first light shielding portion 2111 may be 4.0 μm, and the size SD1 of the first light shielding layer 2211 may be 4.5 μm. The size CD2 of the second light shielding portion 2112 may be 4.5 μm, and the size SD2 of the second light shielding layer 2212 may be 5.0 μm. The size CD3 of the third light shielding portion 2113 may be 3.5 μm, and the size SD3 of the third light shielding layer 2213 may be 4.0 μm.

According to the embodiments of the present disclosure, the size of the light shielding portion at a position where the risk of color mixing is high can be increased, the size of the light shielding portion at a position where the risk of color mixing is low can be reduced. Therefore, the risk of viewing the color mixing by the human eyes can be reduced for the display device without affecting the transmittance.

FIG. 7 schematically illustrates a cross-sectional view of a color filter substrate and an array substrate of a display device, according to an embodiment of the present disclosure, without being accurately aligned. As shown in FIG. 7, the array substrate 22 is shifted to the right relative to the color filter substrate 21, and the pixel electrodes 222 on the array substrate 22 are also shifted to the right accordingly. Although the pixel electrodes 222 controls the deflection of the liquid crystal molecules under the red color block R, the deflected liquid crystal molecules do not extend beyond the range of the second light shielding portion, due to the size CD of the second light shielding portion 2112 being increased. Therefore, the color mixing phenomenon can be avoided.

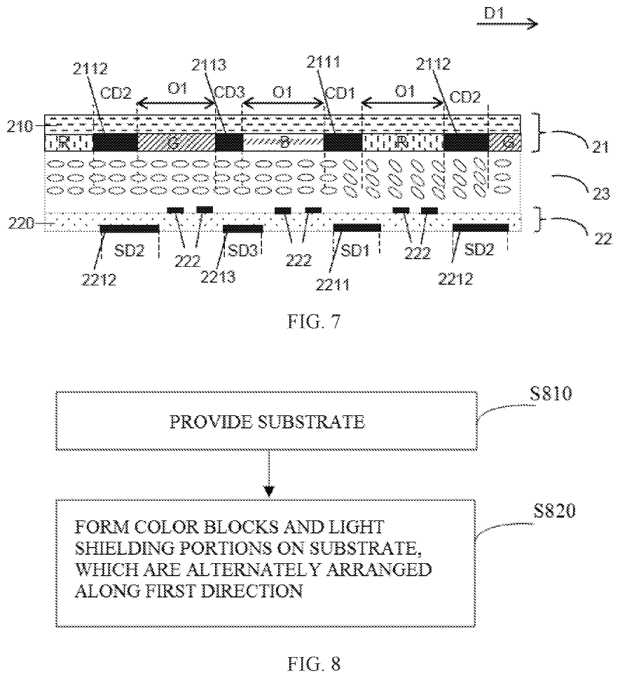

FIG. 8 schematically illustrates a flowchart of steps of a method for manufacturing a color filter substrate according to an embodiment of the present disclosure. In step S810, a substrate can be provided. In step S820, color blocks and light shielding portions can be formed on the substrate. In an embodiment, the color blocks and the light shielding portions are alternately arranged along the first direction. A size of the light shielding portions along the first direction depends on a sensitivity of human eyes to a mixture of colors, which are different, of the color blocks on both sides of each of the light shielding portions.

In an embodiment of the present disclosure, the size of the light shielding portion can be set to be proportional to the sensitivity of the human eyes to the mixture of the colors of the color blocks on both sides of each of the light shielding portions.

In another embodiment, the size of the light shielding portion with the sensitivity of the human eyes to the mixture of the colors of the color blocks on both sides being smaller than a predetermined threshold can be set to be smaller than the size of the light shielding portion with the sensitivity of human eye to the mixture of the colors of the color blocks on both sides being larger than the predetermined threshold.

Though some embodiments of the present disclosure is described in details as above, the scope of protection of the present disclosure is not limited thereto. It will be apparent to those of ordinary skills in the art that various modifications, substitutions, or variations can be made to the embodiments of the present disclosure without departing from the spirit and scope of the present disclosure. The scope of protection of the present disclosure is defined by the appended claims.

1. A color filter substrate comprising:
a substrate;
color blocks positioned on the substrate; and
light shielding portions positioned on the substrate, wherein the light shielding portions and the color blocks are arranged alternately along a first direction,
wherein a size of the light-shielding portions along the first direction depends on a sensitivity of human eyes to a mixture of colors, which are different, of the color blocks on both sides of each of the light shielding portions.

2. The color filter substrate according to claim 1, wherein the size of the light shielding portions is proportional to the sensitivity of the human eyes to the mixtures of the colors of the color blocks on both sides of each of the light shielding portions.

3. The color filter substrate according to claim 1, wherein the size of the light shielding portion with the sensitivity of the human eyes to the mixture of the colors of the color blocks on both sides smaller than a predetermined threshold is smaller than the size of the light shielding portion with the sensitivity of the human eyes to the mixture of the colors of the color blocks on both sides larger than the predetermined threshold.

4. The color filter substrate according to claim 1, wherein the sizes of the color blocks along the first direction are the same.

5. The color filter substrate according to claim 4,
wherein the color blocks comprise a red color block, a green color block, and a blue color block provided in the first direction;
wherein the light shielding portions comprise a first light shielding portion provided between the red color block and the blue color block, a second light shielding portion provided between the red color block and the green color block, and a third light shielding portion provided between the green color block and the blue color block; and
wherein the size of the third light shielding portion is smaller than the size of the first light shielding portion and the size of the second light shielding portion.

6. The color filter substrate according to claim 5, wherein the size of the first light shielding portion is smaller than the size of the second light shielding portion.

7. The color filter substrate according to claim 6, wherein the size of the first light shielding portion is 4.0 μm, wherein the size of the second light shielding portion is 4.5 μm, wherein the size of the third light shielding portion is 3.5 μm, and wherein the sizes of the color blocks is 15 μm.

8. A display device comprising:
a color filter substrate according to claim 1; and
an array substrate, wherein light shielding layers at least partially overlapped with the light shielding portions of the color filter substrate in a direction perpendicular to the substrate are provided on the array substrate at intervals.

9. A method for manufacturing a color filter substrate according to claim 1, the method comprising:
providing a substrate; and
forming color blocks and light shielding portions on the substrate, wherein the color blocks and the light shielding portions are alternately arranged along a first direction, and wherein a size of the light shielding portions along the first direction depends on a sensitivity of human eyes to a mixture of colors, which are different, of the color blocks on both sides of each of the light shielding portions.

10. The method according to claim 9, wherein the size of the light shielding portions is set to be proportional to the sensitivity of the human eyes to the mixture of the colors of the color blocks on both sides of each of the light shielding portions.

11. The method according to claim 9, wherein the size of the light shielding portion with the sensitivity of the human eyes to the mixture of the colors of the color blocks on both sides smaller than a predetermined threshold is set to be smaller than the size of the light shielding portion with the sensitivity of human eye to the mixture of the colors of the color blocks on both sides larger than the predetermined threshold.

12. The color filter substrate according to claim 2, wherein the sizes of the color blocks along the first direction are the same.

13. The color filter substrate according to claim 12,
wherein the color blocks comprise a red color block, a green color block, and a blue color block provided in the first direction;
wherein the light shielding portions comprise a first light shielding portion provided between the red color block and the blue color block, a second light shielding portion provided between the red color block and the green color block, and a third light shielding portion provided between the green color block and the blue color block; and
wherein the size of the third light shielding portion is smaller than the size of the first light shielding portion and the size of the second light shielding portion.

14. The color filter substrate according to claim 13, wherein the size of the first light shielding portion is smaller than the size of the second light shielding portion.

15. The color filter substrate according to claim 3, wherein the sizes of the color blocks along the first direction are the same.

16. The color filter substrate according to claim 15,
wherein the color blocks comprise a red color block, a green color block, and a blue color block provided in the first direction;
wherein the light shielding portions comprise a first light shielding portion provided between the red color block and the blue color block, a second light shielding portion provided between the red color block and the green color block, and a third light shielding portion provided between the green color block and the blue color block; and
wherein the size of the third light shielding portion is smaller than the size of the first light shielding portion and the size of the second light shielding portion.

17. The color filter substrate according to claim 16, wherein the size of the first light shielding portion is smaller than the size of the second light shielding portion.

18. The display device according to claim 8, wherein the size of the light shielding portions is proportional to the sensitivity of the human eyes to the mixtures of the colors of the color blocks on both sides of each of the light shielding portions.

19. The display device according to claim 8, wherein the size of the light shielding portion with the sensitivity of the human eyes to the mixture of the colors of the color blocks on both sides smaller than a predetermined threshold is smaller than the size of the light shielding portion with the sensitivity of the human eyes to the mixture of the colors of the color blocks on both sides larger than the predetermined threshold.

20. The display device according to claim 8,
wherein the sizes of the color blocks along the first direction are the same;
wherein the color blocks comprise a red color block, a green color block, and a blue color block provided in the first direction;
wherein the light shielding portions comprise a first light shielding portion provided between the red color block and the blue color block, a second light shielding portion provided between the red color block and the green color block, and a third light shielding portion provided between the green color block and the blue color block; and
wherein the size of the third light shielding portion is smaller than the size of the first light shielding portion and the size of the second light shielding portion.
